(19) United States
(12) Patent Application Publication
(10) Pub. No.: US 2026/0359101 A1
(43) Pub. Date: Nov. 12, 2026

(54) DEBUGGING PACKET PIPELINES

(71) Applicant: Mellanox Technologies, Ltd., Yokneam (IL)

(72) Inventors: Alan Lo, Boulder, CO (US); Oz Shlomo, Hod Hasharon (IL); Tzah Mazuz, Ramla (IL); Marian Pritsak, Enumclaw, WA (US); Roop Mukherjee, Ottawa (CA); Stephen Warren, Fort Collins, WA (US); Krishna Garlapati, Los Gatos, CA (US); Christopher James Frisz, Hillsborough, NC (US)

(21) Appl. No.: 19/554,239

(22) Filed: Mar. 2, 2026

Related U.S. Application Data
(60) Provisional application No. 63/804,498, filed on May 12, 2025.

(51) Int. Cl. G06F 9/48; G06F 11/362; G06F 11/3698

(52) U.S. Cl. CPC G06F 9/485; G06F 11/362; G06F 11/3698

(57) ABSTRACT

A system includes a network device. The network device is to identify an instruction associated with a program point in program instructions directed to a programming of a network pipeline of the network device; identify an anchor table associated with the program point; add, to the anchor table, data identifying one or more actions corresponding to the instruction, wherein the one or more actions enable code instrumentation of the programming; and cause the network pipeline to resume at the program point, wherein the code instrumentation is propagated to the network pipeline.

### RELATED APPLICATIONS

This application claims priority to U.S. Provisional Patent Application No. 63/804,498, filed May 12, 2025, the entire contents of which are incorporated by reference.

### TECHNICAL FIELD

At least one embodiment pertains to processing resources used to perform and facilitate dynamic debugging of packet processing pipelines in programmable network devices. For example, at least one embodiment pertains to processors or computing systems used to provide and enable a compiler and/or debugger to dynamically insert and modify instructions (e.g., look up tables and actions) during execution of a networking pipeline to enable pipeline insertion, code instrumentation, and pipeline continuation, according to various novel techniques described herein.

### BACKGROUND

Network devices implement packet processing pipelines using match-action table architectures to support flexible, user-defined packet processing logic. Each table entry matches a specified set of lookup keys, and then performs a set of specific network actions. Debugging procedures can help facilitate proper functioning and performance of a network infrastructure that includes network devices. Debugging network devices can involve identifying and resolving issues or errors that occur in the network devices due to programming errors.

### BRIEF DESCRIPTION OF DRAWINGS

Various embodiments in accordance with the present disclosure will be described with reference to the drawings, in which:

FIG. 1 depicts a block diagram of an example computer system environment architecture operating in accordance with one or more aspects of the present disclosure;

FIG. 2 depicts a block diagram illustrating a debug compilation graph, in accordance with one or more aspects of the present disclosure;

FIG. 3 depicts a block diagram illustrating a debugger graph, in accordance with one or more aspects of the present disclosure;

FIG. 4 is a flow diagram of an example method for runtime pipeline insertion, instrumentation, and continuation, in accordance with one or more aspects of the present disclosure;

FIG. 5 is a flow diagram of an example method for implementing a compiler insertion of anchor tables, in accordance with one or more aspects of the present disclosure;

FIG. 6 depicts a block diagram illustrating an exemplary computer device, in accordance with one or more aspects of the present disclosure.

### DETAILED DESCRIPTION

Aspects of the present disclosure are directed to dynamically debugging packet processing pipelines in programmable network devices (e.g., data processing units, smart network interface cards (NICs), data processing units (DPUs), network FPGA, switches, or routers). Programmable logic for networking pipelines can be customized by an end user. A pipeline, such as an application-specific integrated circuit (ASIC) pipeline, can refer to the flow of data and processing stages within a device to achieve efficient execution of a specific application or task. One example of such a pipeline is a packet processing pipeline executing in a programmable network device, which consists of a parser stage followed by a main ingress control stage implemented as a series of interconnected match-action tables connected via hit and miss next-table pointers. Such pipelines can be programmed using a domain specific language, for example. With programmable pipeline processors, a user can flexibly program and add new logic and stages to the pipeline. However, programmed and customized pipelines greatly increase the complexity of both the customer defined logic running on the device and the underlying programmable framework that the pipeline compiler is built on. Conventional systems require hardware reconfiguration to enable instrumentation updates and pipeline extensions. For example, conventional systems stop packet processing for instrumentation updates, or support only passive approaches such as static debug mirroring that duplicates packets and sends them to an external collector, or active tracing that periodically captures packet snapshots at predetermined points. Additionally, pipeline extension functionality is done statically. Such conventional systems do not support tracing of specific match-action sequences, and packet reinjection breaks the pipeline state continuity. When pipeline state continuity is broken during packet reinjection, processing context can be lost, including intermediate metadata values, register states, and parse position information accumulated during preceding pipeline stages. This state loss can result in the reinjected packet to restart processing from the beginning of the pipeline instead of resuming from the point of interruption, effectively negating any prior processing work and creating redundant processing. This disruption can also eliminate the ability to maintain temporal relationships between related packets in a flow, as each packet's processing context becomes isolated from its predecessors and successors. Furthermore, the loss of pipeline state continuity prevents accurate debugging analysis because the debugging tool cannot correlate the packet's current state with the specific sequence of transformations and decisions that led to that state, making it difficult or impossible to trace the exact execution path through the user-defined programmable logic and identify the precise location where errors or unexpected behavior occurred.

Debugging can be particularly difficult in programmable network devices because the user-defined logic can exhibit vastly different execution patterns and behaviors depending on the specific program deployed, the current table entries and rule configurations, and the characteristics of the incoming packet traffic. This variability can mean that no two debugging sessions may exhibit identical packet processing paths, even for packets with similar headers, because the pipeline's behavior is determined by user-written code and dynamically loaded rules. The architectural distinction between programmable network devices and traditional fixed-function devices creates unique debugging challenges that conventional approaches do not adequately address. For example, in traditional fixed-function devices, the packet processing logic is predetermined and immutable, allowing debugging tools to assume fixed pipeline configurations, predetermined match-action table structures, and predefined metadata fields. Consequently, conventional debugging tools can be tailored to a known, unchanging hardware architecture and can hard-code the mapping between hardware data structures and user-visible semantics. In contrast, programmable network devices enable users to synthesize custom match-action table topologies at compile time, implement arbitrary packet header parsing logic through a flexible parser, and construct complex control flow graphs with conditional branching and dynamic next-table selection. These user-defined control structures are typically compiled into hardware table configurations using a compiler, which may perform table merging, table splitting, predicate table insertion, and/or other optimizations that transform the high-level logic into low-level table sequences. This programmability means that the execution path through the pipeline, including the sequence of match-action table lookups, the specific table entries that match each packet, the actions executed at each stage, and/or the metadata and register values modified at each decision point, is data-dependent and program-dependent. Conventional debugging tools, which are designed around fixed pipeline assumptions, cannot dynamically adapt to these user-defined configurations, and therefore cannot provide meaningful insights into the custom logic execution. Additionally, the dynamic nature of programmable pipelines enables runtime modifications to match-action table entries through control plane interfaces, which alter packet processing behavior in real-time without any pipeline reconfiguration or state reset. This means that the same packet presented to the pipeline at different moments in time may be processed via different execution paths due to table entry updates, rule modifications, or changes to register state by concurrent packets or control plane operations. Static debugging approaches that rely on snapshots of table state, pre-recorded traces, or offline analysis cannot capture these temporal variations, and therefore cannot provide a coherent view of how a specific packet was processed in the context of the dynamic rule set that existed when the packet was actively traversing the pipeline. Consequently, developers cannot use passive telemetry, post-hoc analysis, or conventional breakpoint mechanisms to understand the precise interaction between packet processing logic and dynamic rule modifications.

Given the unique challenges posed by programmability, conventional debugging solutions fail to address the complexities incorporated in such devices (e.g., programmable network devices). For instance, some conventional debug methods are low-level (e.g., at the hardware data structure level), and/or are based on fixed pipeline functions that include pipeline data formats that are hard-wired into the device. For example, some conventional network device debugging tools can provide debug data describing a state of the device when the device receives a packet, and a state of the device after the device has processed the packet, but do not provide additional information on how the packet was processed through the customized and programmed pipeline of the device itself. As another example, some network device debugging tools can include telemetry, which involves sending a fixed set of data from a network device as a specific packet to a collector, but does not provide additional information on how the packet was processed through the customized and programmed pipeline of the device itself.

Some programmable pipeline processors enable flexible network logic but lack real-time debugging tools for observing packet behavior during processing. For example, existing methods include passive monitoring, offline analysis, and inference-based debugging. Passive monitoring tracks port/flow-table counters or packet drops, which provides only indirect, post-processing insights. Offline analysis captures packet traces or telemetry data for later review, which provides delayed feedback and does not allow for live interaction. Inference-based debugging relies on a user to deduce pipeline behavior from final packet states, which can be error-prone and can miss the intermediary steps of the pipeline.

Aspects of the present disclosure address the above-noted and other deficiencies by providing dynamic runtime pipeline interception, instrumentation, and continuation that can be used to debug packet pipelines for programmable network devices. The technique for runtime action interception can involve creating an anchor table prior to each action that can be intercepted in the programmable pipeline. An anchor table can refer to a match-action table structure that can function as a programable interception mechanism within the packet processing pipeline. In some embodiments, the anchor table is initially configured with one or more placeholder entries or remains empty upon creation, and is subsequently populated with dynamically insertable action entries that enable runtime modification of packet flow behavior. In some embodiments, the debugger can insert user-defined instructions that are injected to the pipeline. These instructions can be any hardware level instruction. For example, these instructions can be additional tables with entries performing packet filtering. A separate just in time pipeline can be generated by the debugger user. In some embodiments, a compiler can create and/or insert an anchor table prior to each action that can be intercepted, or prior to a subset of actions that can be intercepted. In some embodiments, a debugger tool can create and/or insert the anchor table(s). In some embodiments, a single anchor table can be used by multiple table entries that utilize the same action template, thus avoiding having to update all table entries. As an illustrative example, multiple table entries that perform “forward to port X” actions can share the same action template, where only the port number varies, allowing a single anchor table to intercept all forwarding actions rather than requiring separate anchor tables for each port destination.

The compiler and/or the debugger tool can update the entries in the anchor table actions. In some embodiments, the compiler (e.g., a just in time compiler) can convert high-level rules, e.g., provided by a user, into instructions for live insertion into anchor tables. The entries can include instructions to encapsulate the packet and divert the encapsulated packet to the debugger. The debugger can enable code instrumentation through various approaches, such as by modifying the original pipeline logic directly within the network device, dynamically activating or deactivating specific pipeline stages during operation, and/or executing instrumentation code within the debugger itself (e.g., before reinjecting packets back to the pipeline). The instrumented code can be executed in the same hardware unit (e.g., counter instrumentation), a hardware coprocessor, and/or in software (e.g., a dynamic debugger). For example, a hardware coprocessor can include a dedicated packet processing unit that operates alongside the main pipeline processor, while software execution can occur on a CPU connected to the network device. The diverted packet can be reinjected back to the hardware pipeline (e.g., using a reinjection table) at the location succeeding the interception point. Such reinjection allows software to seamlessly extend a hardware pipeline.

The interception, instrumentation, and continuation techniques described herein enable action list interception, runtime packet processing code instrumentation, and the extension of hardware pipeline in software, including continuing processing after the point of invocation. The dynamic pipeline modification can support pipeline versioning by dynamically inserting a shadow pipeline with new rules based on existing flow entries, with little to no downtime to switch over to the shadow pipeline. For example, a shadow pipeline may be created to test new load balancing algorithms by duplicating existing forwarding rules and adding experimental traffic distribution logic. The use of a shadow pipeline can allow validation before switching production traffic to the new pipeline version. The interception, instrumentation, and continuation techniques can be used, for example, to create a runtime debugger with dynamic breakpoints and stepping functionality, dynamic counter insertions, and dynamic table and rule insertions. In some embodiments, the same techniques can be used to create and operate alternative pipelines, including steering traffic between active and shadow pipelines. Traffic can be gradually migrated based on traffic classification, or atomically switched over all at once.

A use case of the interception, instrumentation, and continuation technique described throughout is a dynamically configurable pipeline debugger that can single step through the packet processing pipeline of a network device. On each step through the hardware pipeline execution, the packet state, including headers, metadata and registers, can be stored with the packet and diverted to a debugger tool. Using the interception, instrumentation, and continuation techniques described herein ensures that, when reinjected by the software debugger, the pipeline state (e.g. registers, metadata, packet contents) remains consistent across the hardware/software boundary, allowing the debugger tool to effectively function as an extension of the pipeline. Furthermore, in some embodiments (e.g., when desired by the user), the debugger can dynamically modify state, place debugging filters, and continue the packet processing with minimal or no interruption in the pipeline (e.g., without loss of pipeline state, and with no service interruption to unaffected traffic). The techniques described throughout enable the dynamic and/or conditional insertion of breakpoints in a pipeline, the diversion of the packet with debugging information off the pipeline to the debugger tool, modification of the packet state along with pipeline register values and metadata, and reinjection of the packet to the pipeline at the point the packet left the pipeline. In some embodiments, the compiler can mark the interception points, and the debugger tool can dynamically install anchor tables and/or runtime rules with debugging instructions at the interception points. In some implementations, the packet can then be recirculated out of and back into the pipeline, effectively using the packet as a program counter.

In some embodiments, the runtime instructions can implement multiple encapsulations by copying the packet's state (e.g., headers, metadata, registers, etc.) into a buffer while preserving the original packet as an inner payload. The runtime instructions can divert the encapsulated packet to a debugger tool. The debugger tool can enable conditional breakpoints, allowing a user to set, modify, and/or remove interception points dynamically during program execution; view and/or alter packet fields, metadata, and/or register values mid-pipeline; and reinject the packet to resume processing from the pipeline stage at which the packet was diverted, or to an arbitrary point that the debugger may choose. For example, the debugger can reinject a packet at an earlier pipeline stage to test alternative processing paths, or skip certain pipeline stages to simulate different network conditions or bypass problematic processing logic during troubleshooting.

Aspects of the present disclosure can include a compiler for processing programmable pipeline code with integrated debug instructions, a pipeline configuration and runtime system, and mechanisms for debug data acquisition and analysis. The compiler can insert anchor tables at identified program points in the program instructions. In some embodiments, the program points can be user selectable, for example at the source code level, and/or automatic, for example at the hardware instruction level. In some embodiments, the anchor tables can be initially empty, and the debugger can dynamically modify the anchor tables by adding action entries. In some embodiments, the anchor tables inserted by the compiler can include at least some predefined action entries. The action entries can be conditional or unconditional. The action entries can include instructions to encapsulate a packet advancing through the networking pipeline and divert the encapsulated packet to a debugger. The encapsulated packet can include a buffer that stores the pipeline state information, register states, and/or parser position, for example. The debugger can enable a user to analyze the packet and the data stored in the buffer. The debugger can also enable a user to modify the values of the data stored in the buffer and the packet during the debugging process.

In some embodiments, following analysis and any modifications, the debugger can cause the encapsulated packet to be reinjected into the network pipeline at the point at which the packet was diverted to the debugger, e.g., using a dynamic mapping table. In some embodiments, a mapping table can refer to a lookup data structure that establishes associative relationships between unique identifier keys and their corresponding target locations or operational parameters. In some embodiments, the mapping table can enable systematic retrieval of destination information based on input identifiers. The action entries in the dynamic mapping table can cause the packet to be redirected to the point in the pipeline immediately succeeding the point at which the packet was diverted to the debugger, thus continuing the flow of the network pipeline. An action entry in the dynamic table can cause the state of the pipeline to be restored to the values stored in the buffer of the packet, thus enabling code instrumentation. That is, the user can dynamically change values while the packet is diverted to the debugger, and the changes can be propagated when the packet is reinjected into the network pipeline.

Advantages of the present disclosure include, but are not limited to, providing deep visibility into how a packet is processed by a customized and interactive programmable pipeline associated with a network device. Aspects of the present disclosure provide direct access to a packet's state (e.g., headers, metadata, registers) at specific pipeline stages, leading to deep visibility into how packets are processed that does not rely on inferring packet behavior from counters or post-processing traces. Additionally, aspects of the present disclosure enable the modification of packet fields or metadata mid-pipeline and resume execution, enabling controlled testing of specific code paths. Aspects of the present disclosure maintain pipeline state continuity during debugging operations, preserving processing context including intermediate metadata values, register states, and/or parser position information that would otherwise be lost with conventional debugging approaches. The packet reinjection techniques described herein enable a packet to continue operation allows precise single-stepping through a network pipeline, and the integrated breakpoint system combines compile-time interception points with runtime table and rule installation. These capabilities significantly reduce development cycle time by enabling iterative testing and modification of pipeline logic without requiring pipeline reconfiguration or service interruption, allowing developers to rapidly prototype and validate changes to programmable network logic. Such techniques can be used to create a dynamic runtime debugger, which can provide direct identification of errors (not inferred) in the programmed instructions that enable developers to diagnose and correct issues in the logic, thus improving the overall performance of the system on which the network device is executed. Aspects of the present disclosure leverage existing pipeline resources for debugging operations, reducing or eliminating the need for dedicated hardware or separate monitoring infrastructure, thereby reducing system complexity and hardware costs while providing comprehensive debugging functionality through the programmable pipeline itself.

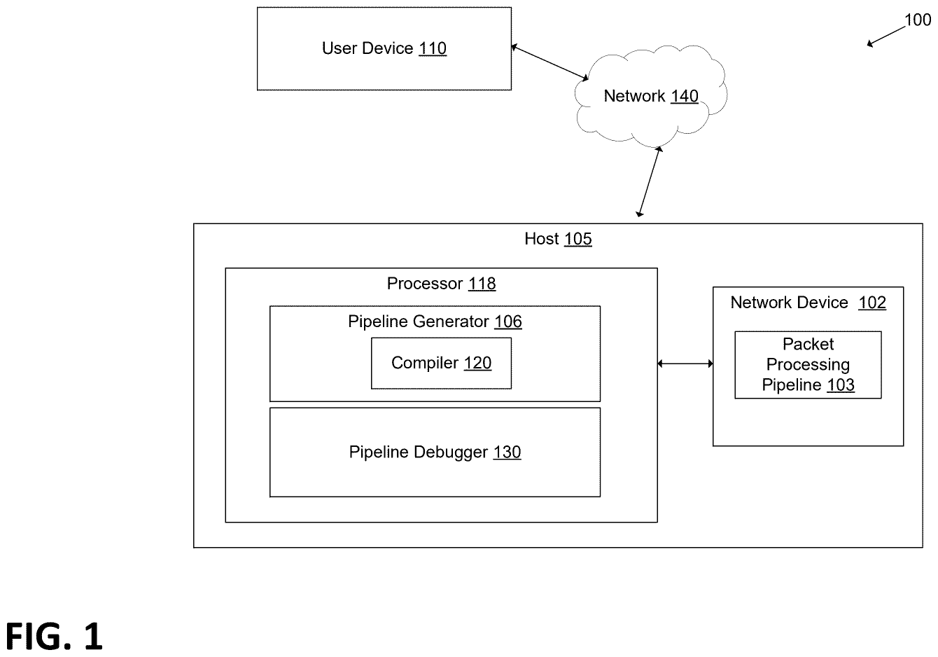

FIG. 1 illustrates an example computing environment 100, in accordance with embodiments of the present disclosure. It should be noted that other architectures for computing environment 100 are possible, and that the implementation of a computing environment utilizing embodiments of the present disclosure are not necessarily limited to the specific architecture depicted. Computing environment 100 may be a computing environment that is configured to provide on-demand availability of computing resources to consumers without direct management by the consumers. In one example, computing environment 100 may be a cloud computing environment (e.g., public cloud, private cloud, hybrid cloud) and the user devices and host devices may be associated with different entities (e.g., cloud consumer v. cloud provider). In another example, computing environment 100 may be an on-premises computing environment in which the user devices and host devices are associated with the same entity (e.g., same company, enterprise, or business entity). In the simplified example of FIG. 1, computing environment 100 may include a user device 110, a host device 105, and a network 140.

User device 110 may be any computing device that consumes the computing resources of host device 105 and may provide input data (e.g., code and/or configurations) that enable the host device 105 to execute computing tasks on behalf of user device 110. User device 110 may include one or more servers, workstations, desktop computers, laptop computers, tablet computers, mobile phones, robotic devices (e.g., drones, autonomous vehicles), personal digital assistants (PDAs), smart watches, other devices, or a combination thereof.

Host device 105 may be a single host machine or multiple host machines arranged in a heterogeneous or homogenous group (e.g., cluster). In one example, host device 105 may be or include one more servers, workstations, personal computers (e.g., desktop computers, laptop computers), mobile computers (e.g., mobile phones, palm-sized computing devices, tablet computers, personal digital assistants (PDAs)), data storage devices (e.g., USB drive, Network Attached Storage (NAS), Storage Area Network (SAN)), network devices (e.g., routers, switches, access points), other devices, or a combination thereof.

Host device 105 may include multiple primary devices that include one or more resources, such as main memory (not pictured) and/or one or more processors 118. The processor 118 may be or include a Central Processing Unit (CPU) and may be referred to as the primary processor, host processor, main processor, other term, or a combination thereof. The processor may have an Instruction Set Architecture (ISA) that is the same or similar to x86, ARM, Power ISA, RISC-V, SPARC, MIPS, other architecture, or a combination thereof. The processor 118 may be coupled to memory, which may be shared by one or more devices of host device 105. The memory may be referred to as main memory, host memory, primary memory, other term, or a combination thereof. Host device 105 may include one or more virtualized computing environments (e.g., virtual machines, containers, etc.). A virtualized computing environment can include multiple virtual machines managed, for example, by a virtual machine monitor, a hypervisor, a host operating system (OS), etc. In other embodiments, a virtualized computing environment can include one or more containers managed, for example, by a host OS. Host device 105 may include or be coupled with one or more network devices 102. A network device 102 can be, for example, a data processing units (DPU) device, a network interface card (NIC), a switch, a network FPGA, or any other network device. Processor 118 can be part of a controller (not pictured) executed on host 105. The controller can manage and/or control the operations of the network device 102. The controller can be part of the host device 105. In some embodiments, the controller (e.g., processor 118, or parts of the processor 118) can be implemented in a separate physical device connected through a network (e.g., network 140). For example, the network device 102 can send packets to the pipeline debugger 130 operating on processor 118 using packet encapsulation and/or tunneling techniques. In other embodiments, the controller (e.g., processor 118, or parts of the processor 118), can be implemented by a virtual machine. For example, the pipeline debugger 130 can be implemented by a virtual machine that is connected to host 105, or a hypervisor to which the network device 102 is connected.

A network device 102 may be a computing device that is communicably coupled with host device 105 and may perform one or more data processing tasks for host device 105, such as a data process unit (DPU) device, a programmable switch, or a smart NIC, for example. Network device 102 may be internal or external to host device 105 and may be a peripheral device (e.g., PCIe device) in the form of a physical adapter, card, component, module, or other device that is physically located on the same chassis as host device 105 (e.g., same board, case, tower, rack, cabinet, room, building) or on a different chassis. Network device 102 may perform data processing tasks that are the same or similar to the data processing tasks performed by the processor of the host device 105, or may perform data processing tasks that are not performed by the processor of the host device 105.

The network device 102 can be a programmable device, such as a smart network interface card (NIC). A programmable network device can be described as a network device that can be configured and controlled through software or programming. In some embodiments, the network device 102 can process packets received from, e.g., user device 110 via network 140. Thus, a programmable device, such as network device 102, can include programmed instructions defining the processing of packets. A controller (e.g., executing processor 118) can include a pipeline generator 106 and/or a pipeline debugger 130. The pipeline generator 106 can include a compiler 120. In some embodiments, the compiler 120 can receive code (e.g., from user device 110, from another component implemented on host 105, and/or from another device connected to network 140). The code can include logic to program a packet processing pipeline executable by the network device 102. The compiler 120 can compile the code into machine-readable instructions that the network device 102 can execute. Note that the pipeline generator 106 and/or the compiler 120 can run on a processor other than processor 118 (i.e., the pipeline generator 106 and the pipeline debugger 130 can run on separate processors). In some embodiments, the pipeline generator 106 and/or the compiler 120 can run on the network device 102.

In some embodiments, multiple table entries that utilize the same action template can share a single anchor table, avoiding the need to update all individual table entries. For example, multiple table entries that perform the “forward to port X” actions can share the same action template where the port number varies, allowing a single anchor table to intercept all forwarding actions rather than requiring separate anchor tables for each port destination. In some embodiments, a template can refer to a standardized operational framework that defines a common set of processing operations with parameterizable elements, where multiple distinct implementations can reference the same template structure while utilizing different variable values or configuration parameters to achieve functionally similar but contextually specific processing behaviors.

In some embodiments, the anchor table sharing mechanism can operate by creating a template-based lookup structure where each action template defines a common set of operations with variable parameters. When multiple table entries reference the same action template, the compiler 120 can generate a single anchor table that includes parameterized match conditions and actions capable of handling all variations of the template. For instance, a “forward to port” action template can include a port parameter field that can be dynamically populated based on the specific table entry being processed. The anchor table maintains a mapping between template identifiers and their corresponding parameter sets, enabling a single anchor table to service multiple flow table entries while preserving the specific parameter values (e.g., port numbers, VLAN tags, quality-of-service markings, etc.) associated with each individual table entry.

The code can define a pipeline (or multiple pipelines) for the network device 102 to process packets. The compiler 120 can identify debug instructions that are associated with program points in the code. The program points can correspond to various actions in the pipeline that can be intercepted. In some embodiments, an action can refer to a discrete operational command or executable instruction that specifies processing behavior to be applied to a packet or data element. The action can specify, for example, computational steps, data transformations, and/or routing decisions that the network should perform as part of the packet processing workflow. In some embodiments, the compiler 120 can identify program points in the code that can be intercepted, rather than (or addition to) relying on debug instructions to identify the program points. During compilation, the compiler 120 can insert anchor tables at identified program points. In some embodiments, the debug instructions can be identified based on input received from the user device 110, and/or by another component executing on host 105.

In some embodiments, the compiler 120 can include just-in-time (JIT) compilation capabilities that convert high-level rules provided by users into machine-readable instructions for live insertion into anchor tables. The high-level rules can specify debugging instructions, such as packet filtering criteria, instrumentation requirements, and/or breakpoint conditions, that are dynamically translated into executable pipeline instructions during runtime. The JIT compilation process can enable dynamic rule translation by parsing user-defined debugging specifications and converting them into optimized machine instructions that can be directly inserted into anchor tables during pipeline execution. This real-time compilation capability allows the debugging system to adapt to changing debugging requirements without requiring pipeline reconfiguration or service interruption, as the JIT compiler can generate and deploy new anchor table entries based on evolving user specifications or automated debugging policies.

Once compiled, the pipeline generator 106 can load the compiled code onto the network device 102. For example, the pipeline generator 106 can transfer a firmware image that includes the compiled code to memory of the network device 102, or can transfer the code directly to the network device 102.

As illustrated in FIG. 1, the network device 102 can include a packet processing pipeline 103. The packet processing pipeline 103 can receive and execute the compiled machine-readable instructions from the pipeline generator 106. The packet processing pipeline 103 can process received packets (e.g., received from user device 110). During execution of the packet processing pipeline 103, the pipeline debugger 130 can install runtime rules based on user commands. The runtime rules can be inserted at the interception points identified by the compiler 120. The runtime rules can be inserted into an anchor table, such as adding actions (conditional and/or unconditional) to the anchor table(s).

In some embodiments, the pipeline debugger 130 can dynamically insert one or more shadow pipelines that operate concurrently with the active pipeline. A shadow pipeline can refer to a concurrently instantiated version of the pipeline (or of a portion of the pipeline) that can be constructed alongside the active pipeline and populated with rules derived from existing flow entries, optionally augmented or modified by new logic. A shadow pipeline can enable pipeline versioning by allowing new rules and/or logic to be tested alongside existing flow entries with minimal downtime during switchover. For example, the debugger 130 can create a shadow pipeline to test new load balancing algorithms while the active pipeline continues processing production traffic, enabling validation before migrating to the updated pipeline version.

In some embodiments, the instrumented code generated by the debugger 130 can be executed in various environments, including the same hardware unit as the main pipeline (e.g., for counter instrumentation), a dedicated hardware coprocessor that operations alongside the main pipeline processor, and/or in software on the host processor 118. This flexibility can allow the debugging system to adapt to different performance requirements and/or hardware configurations while maintaining debugging functionality.

In some embodiments, the debugger 130 can provide adaptive counter insertion capabilities that enable dynamic monitoring of packet processing metrics without requiring pre-configured instrumentation points. Counters can be inserted and/or removed at runtime based on observed traffic characteristics and/or user-specified criteria, allowing the debugger 130 to adjust its monitoring granularity in response to current network conditions. For example, the debugger 130 can detect high packet drop rates at specific pipeline stages and insert counters to track the specific causes to packet drops, such as buffer overflow conditions or rule matching failures.

In some embodiments, the debugger 130 can support dynamic table and/or rule insertion during runtime, enabling the modification of packet processing logic without interruption pipeline operation. This capability allows users to insert new match-action tables, modify existing rule sets, and/or add new processing stages to the active pipeline while packets continue to be processed. The dynamic insertion mechanism can coordinate with the anchor table infrastructure to properly integrate new tables into the packet processing flow, so that existing packet flows are not disrupted during the insertion process.

In embodiments utilizing hardware coprocessor execution, the instrumentation code can be offloaded to dedicated process units that operate in parallel with the main processor 118. These hardware coprocessors can perform specialized instrumentation tasks such as deep packet inspection, cryptographic operations, and/or complex statistical analysis with the main pipeline continues processing packets at line rate. The coprocessor execution model can enable resource-intensive debugging operations to be performed without impacting the performance of the primary packet processing pipeline.

In some embodiments, the debugger 130 can implement stateful hardware/software transition mechanisms that maintain processing context when packets are transferred between hardware pipeline stages and software debugging components. The transition mechanisms can preserve packet metadata, register values, and/or processing history across the hardware/software boundary, so that debugging operations have access to complete packet processing context. The stateful transitions can enable seamless integration between hardware-accelerated packet processing and software-based debugging analysis, allowing for comprehensive debugging capabilities that leverage both hardware performance and software flexibility.

The runtime rules can include instructions to encapsulate a packet by copying the packet's state (e.g., headers, metadata, registers) into a buffer of the packet, while preserving the original packet as an inner payload. The runtime rules can include an instruction to divert the encapsulated packet to a debugger 130. The debugger 130 enables conditional breakpoints, live inspection and modification, and/or single-stepping. That is, the debugger tool 130 enables a user to set, modify, and/or remove interception points dynamically during execution. The debugger 130 enables a user to view or alter the packet fields, metadata, and/or register values mid-pipeline. The debugger 130 enables the packet to be reinjected to the network pipeline, and to resume processing from the pipeline stage where it paused. In some embodiments, the recirculation mechanism reuses the packet itself to track pipeline progress, enabling precise control flow. In some embodiments, the runtime associates a debug hook with each primitive hardware action (e.g. ALU operation, match or table jump). A debug packet can pause between each such primitive step, allowing the debugger to drive an instruction level single-step execution of the packet pipeline.

In some embodiments, the debugger 130 can insert conditional actions into the anchor tables that direct packets to debugging operations when specific packet characteristics satisfy predetermined criteria. For example, conditional breakpoints can be configured to trigger based on source or destination IP addresses, specific protocol fields, VLAN identifiers, packet size thresholds, and/or custom protocol headers. This conditional filtering can enable developers to focus debugging efforts on specific traffic patters or network conditions without interrupting the processing of unrelated packets. In some embodiments, the conditional breakpoint mechanism can support complex filtering rules that combine multiple packet characteristics using logical operators. For instance, a debugging rule can specify “break when source IP is within subnet 10.0.0.0/8 AND destination port is 80 AND packet contains HTTP GET request,” allowing for precise targeting of specific network communications. These conditional rules can be dynamically updated during debugging sessions, enabling users to refine their debugging focus as they investigate different aspects of packet processing behavior without requiring pipeline reconfiguration.

In some embodiments, the runtime instructions can implement double or multiple encapsulation by copying the packet's state (e.g., headers, metadata, registers, etc.) into a buffer while preserving the original packet as an inner payload. This multiple encapsulation technique creates a nested data structure where the original packet remains intact as the core payload, while pipeline state information, including register values, metadata fields, and/or parser position data, is systematically copied into designated buffer areas within the encapsulated packet structure. In some embodiments a network device can use standard tunnel protocols, e.g. virtual extensible local-area network (VxLAN) or GENEVE, as the debug encapsulation layer, allowing existing infrastructure to parse and route debug packets without additional hardware support. In some embodiments, standard optional extensions such as IP options can be used as a buffer.

In some embodiments, the multiple encapsulation process can enable comprehensive state preservation by creating distinct buffer regions for different types of pipeline state information. For example, one buffer region may store packet header modifications and metadata changes, while another buffer region preserves register states and control flow information that accumulated during the packet's traversal through preceding pipeline stages. This layered approach ensures that all critical processing context is maintained and can be accurately restored when the packet is reinjected back into the pipeline. Such layer can be used to separate concerns or to comply with hardware encapsulation limitations.

In some embodiments, the compiler can mark the interception points, and the debugger 130 can dynamically install anchor tables and/or runtime rules with debugging instructions at the interception points. In some implementations, the packet can then be recirculated out of and back into the pipeline, effectively using the packet as a program counter. Using the packet as a program counter can enable packets to carry their own execution state information as they traverse through the pipeline stages. In this approach, the actual pipeline location can be stored in the buffer of the packet, allowing the debugger 130 to determine precisely where in the pipeline the packet originated and where it should be reinjected after debugging operations are completed. This self-contained progress tracking mechanism can reduce or eliminate the need for external control systems to maintain packet flow and enables packing routing through the debugging process.

In some embodiments, using the packet as a program counter can allow the debugger 130 to modify the stored pipeline location information, enabling advanced debugging capabilities such as arbitrary packet redirection within the pipeline. For example, the debugger 130 can change the pipeline location identifier to reinject a packet at an earlier pipeline stage to test alternative processing paths, or advance the packet to a later stage to bypass certain processing logic during troubleshooting. This flexibility can provide developers with precise control over packet flow during debugging while maintaining the integrity of the pipeline execution model.

In some embodiments, the pipeline debugger 130 can create and manage a dynamic mapping table that maps debug point identifiers to their corresponding pipeline locations, enabling packets that have been diverted for debugging to be reinjected at the precise location stage where they were intercepted. This reinjection mechanism preserves pipeline state continuity by restoring packet metadata, register values, and/or parser position information from the encapsulated buffer, allowing debugging operations to occur without disruption the normal packet processing flow. In some embodiments, when the debugger 130 reinjects a packet to non-sequential pipeline stages, the restoration mechanism can selectively apply compatible state information from the encapsulated buffer while omitting or re-deriving metadata that may no longer be valid for the target pipeline location. For example, when rewinding to an earlier stage, certain register values or parser position indicators that were accumulated during subsequent processing may be excluded from restoration to prevent inconsistent pipeline state. Conversely, when skipping forward to later stages, the restoration process may synthesize missing intermediate metadata or utilize default values for state variables that would normally be populated during the bypassed processing stages, ensuring that the target pipeline stage receives appropriately formatted input data for continued execution.

In some embodiments, the reinjection tables can include a set of lookup structures that maintain mappings between debug point identifiers and their corresponding pipeline stage locations, enabling precise packet redirection after debugging operations are completed. Each reinjection table entry can include a debug point identifier, a target pipeline stage address, and/or restoration metadata that specifies the pipeline state information for seamless packet continuation. The reinjection mechanism can utilize these tables to determine the exact pipeline location where a debugged packet should resume processing so that the packet continues from the precise point where it was intercepted rather than restarting from the beginning of the pipeline.

In some embodiments, the buffer restoration mechanism can implement a state recovery system that extracts pipeline state information from the encapsulated packet buffer and restores the network device's processing context to match the state that existed when the packet was originally intercepted. The restoration process includes reloading register values, metadata fields, parser position indicators, and/or control flow state variables from the buffer into the corresponding hardware or software structures within the network device 102. The buffer format can include structured data fields that specify the memory locations and/or data types for each state element, enabling the restoration mechanism to reconstruct the pipeline processing environment and provide continuity of packet processing operations.

In some embodiments, the recirculation mechanism for control flow management can utilize the packet itself as a carrier of execution state information, implementing a packet-as-a-program-counter approach where each packet maintains its current pipeline position and processing history. The recirculation mechanism can include a packet state tracking module that updates the packet's internal control information as it progresses through pipeline stages, and a flow control manager that coordinates packet routing based on the embedded state information. When a packet is diverted for debugging and subsequently reinjected, the recirculation mechanism can read the packet's embedded state information to determine the appropriate pipeline stage for continuation, enabling control over packet flow without external state management systems or complex synchronization protocols.

In some embodiments, the pipeline debugger 130 can receive a packet from the data plane and thus can act as an extension of the pipeline. Thus, hosting the pipeline debugger 130 on the host 105 can reduce latency. However, in some embodiments, the pipeline debugger 130 can operate on a separate device (e.g., on user device 110, or on another device not pictured). In some embodiments, the pipeline debugger 130 can operate within a remote controller (e.g., the pipeline debugger 130 may not be directly attached to a physical port of the network device 102). In some embodiments, the compiler 120 can operate on a separate device (e.g., on user device 110, or on another device not pictured), and the compiled executable can be loaded to network device 102 remotely via network 140. That is, in some embodiments, compiler 120 is offline and off box, and can statically generate the executable to be loaded on network device 102.

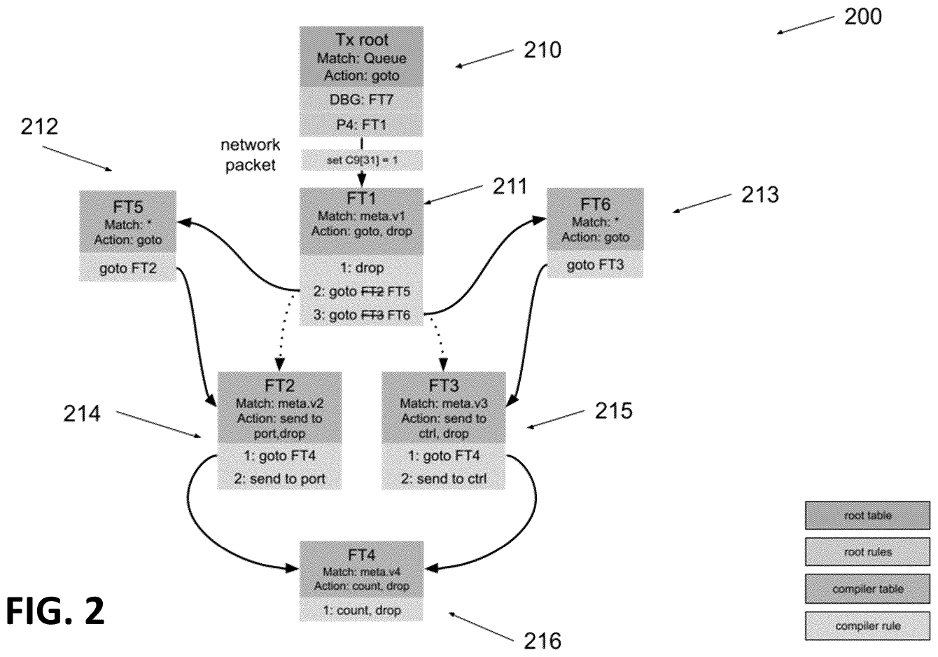

FIG. 2 depicts a block diagram illustrating a debug compilation graph 200, in accordance with the one or more aspects of the present disclosure. In some embodiments, a compiler (e.g., compiler 120 of FIG. 1) establishes (e.g., defines) match action tables (sometimes referred to as a flow table or a forwarding table). Match action tables can be used to determine how network packets are processed and forwarded through a processing pipeline (such as packet processing pipeline 103). A match action table can include match fields and the associated action(s). A match field describes the criteria and/or attributes used to match incoming packets against entries in the match action table. Match fields can include packet header fields, such as source and/or destination IP addresses, port numbers, protocol types, VLAN tags, and/or any other relevant packet information. In some embodiments, the match field can include match criteria (e.g., a match key). The matched action(s) describe actions to be performed on the packet(s) that match specific match field conditions (e.g., match the criteria and/or attributes described in the associated match field). An action can include multiple sub-actions, such as forwarding the packet to a specific port or interface, modifying the packet header fields, applying quality of service policies, dropping the packet, and/or sending the packet to a different processing pipeline.

FIG. 2 illustrates a network of interconnected match action tables 210-216. Table 210 can be a transmit root table, and tables 211-216 can be flow tables generated by the compiler during the compilation process. In some embodiments, when the program is compiled in debug mode, the compiler can identify certain points in the program to insert anchor flow tables. The compiler can identify each action that can be intercepted as a point at which to insert an anchor table, or can identify certain actions that have been identified as a point in the program at which to insert an anchor table. For example, a user can identify at which point in the program to insert an anchor table. In some embodiments, tables 210-216 can be arranged in a hierarchical structure where packets flow through multiple stages based on match conditions and corresponding actions. The debug compilation graph 200 can include a transmit root table 210 that can serve as the entry point for packet processing. Connected to root table 210 is match action table FT1 table 211. Table 211 can represent a primary flow table in the pipeline. In some embodiments, in the debug compilation model, the compiler has inserted additional match action table FT1 table 211, as well as additional anchor table 212 and 213 at strategic program points where debugging operations can be performed. In some embodiments, anchor tables 212 and 213 can be positioned between the original flow tables to create interception points without disruption the packet processing flow.

The graph 200 demonstrates how match action table 211 branches into two paths. One path leads to anchor table 212, which subsequently connects to match action table 214, and another path leading to anchor table 213, which subsequently connects to match action table 215. Match action tables 214 and 215 further connect to match action table 216, which can complete the processing pipeline in embodiments.

As illustrated in FIG. 2, tables 212 and 213 can be anchor tables created and inserted by the compiler. Thus, in some embodiments, when executing the program not in debug mode, the actions of flow table 211 can be go to FT2 table 214 and go to FT3 table 215. When executed in debug mode, the compiler can identify the go to actions of FT1 table 211 as points at which to insert an anchor table (e.g., as identified by a user, or as identified as an action that can be intercepted), and can create and insert an anchor table at each go to action. Thus, the first go to action of FT1 table 211 is modified to send the packet to FT5 table 212, and the second go to action of FT1 table 211 is modified to send the packet to FT6 table 213. The action of FT5 table 212 is to go to FT2 table 214, and the action of FT6 table 213 is to go to FT3 table 215, thus mirroring the flow of the program executed not in debug mode.

In some embodiments, anchor tables 212 and/or 213 can function as placeholder structures that may initially be empty when created by the compiler but can be dynamically populated by the debugger tool during runtime. Thus, anchor tables 212 and/or 213 can enable packet interception, state capture, and/or debugging operations without modifying the original pipeline architecture.

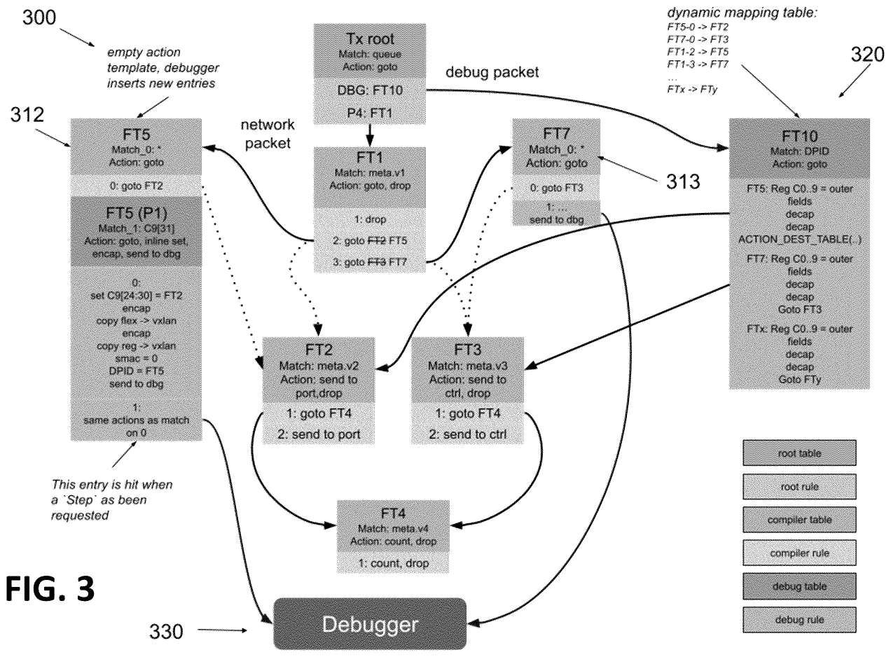

FIG. 3 depicts a block diagram illustrating a debugger graph 300, in accordance with the one or more aspects of the present disclosure. Debugger graph 300 can demonstrate how the debugger (e.g., debugger 130 of FIG. 1) dynamically inserts entries into the anchor tables (e.g., anchor tables 212 and 213 of FIG. 2, and anchor tables 312 and 313 of FIG. 3) created by the compiler and manages packet flow through the debugging process. The graph 300 shows the operational state of the packet processing pipeline when debugging operations are actively engaged.

In some embodiments, the debugger (e.g., debugger 130 of FIG. 1) can insert entries into the empty anchor tables created by the compiler. For example, anchor table 312 can be an anchor table inserted by the compiler (e.g., as described with respect to FIG. 2), and the debugger can insert actions into the anchor table 312. The actions (or a subset thereof) inserted into anchor table 312 can divert the packet to a debugger tool 330. These actions can be conditional and/or unconditional, allowing the debugger to selectively intercept packets based on predetermined criteria such as IP addresses, protocol fields, and/or other packet characteristics. Anchor table 312 contains entries that implement packet encapsulation by copying the packet's state (e.g., headers, metadata, and/or registers) into a buffer while preserving the original packet as an inner payload.

The debugger tool 330 can serve as an interactive debugging environment. The debugger tool 330 can enable a user to set, modify, and/or remove interception points dynamically during execution. When packets are diverted to the debugger tool 330, users can view and/or alter packet fields, metadata, and/or register values mid-pipeline. The debugger tool 330 provides capabilities for conditional breakpoints, live inspection and modification, and/or single-stepping through the pipeline execution. The debugger tool 330 can reinject back into the network pipeline, and the packet can be sent back into the pipeline at the point at which it left, according to the dynamic mapping table 320. In some embodiments, the debugger tool 330 can create and insert the dynamic mapping table 320. The dynamic mapping table 320 can include instructions to reinstate the state of the packet (e.g., registers, metadata), according to the values in the buffer.

In some embodiments, the dynamic mapping table 320, which can be created and/or managed by the debugger tool 330, can maintain mappings between debug point identifiers and their corresponding pipeline locations. The dynamic mapping table 320 can include instructions to restore the state of the packet according to the values stored in the buffer, so that when the packets are reinjected, they resume processing with the context that existed when they were intercepted. In some embodiments, the user selects alternative pipeline locations that the debugger will reinject the packet, to resume processing at a location not related to the original point of interception.

In some embodiments, the debugger 330 can insert conditional actions into the anchor table that can direct a packet to a different version of the network pipeline. The debugger 330 can dynamically insert a shadow pipeline (e.g., illustrated as FT5(P1) of table 312 in FIG. 3), which can include a conditional debug rule. A shadow pipeline can refer to a concurrently instantiated version of the pipeline (or of a portion of the pipeline) that can be constructed alongside the active pipeline and populated with rules derived from existing flow entries, optionally augmented or modified by new logic. In some embodiments, the shadow pipeline is compiled and loaded while the active pipeline continues to process traffic, and a controller can configure a top-level selector to steer packets either to the active pipeline or, when ready, to the shadow pipeline without interrupting service. In some embodiments, the debugger 330 can migrate entries from the active pipeline to the shadow pipeline, synchronize or transform rule parameters as needed, and progressively enable the shadow pipeline for selected traffic classes (e.g., per flow, per queue, and/or per match criteria) to validate behavior before a complete switchover. In some embodiments, when interception points and/or runtime-insertable tables are already present, the shadow pipeline can be introduced, exercised, and/or activated dynamically and atomically, and a return path can remain available to revert to the prior version if validation fails. Validation can involve comparing the shadow pipeline's packet processing results against the active pipeline's output, monitoring for errors or unexpected behavior, and verifying that the new functionality operates correctly under various traffic conditions. If the validation process detects failures, performance degradation, or incorrect behavior in the shadow pipeline, a return path mechanism allows the system to revert back to the prior pipeline version. This approach enables pipeline versioning, A/B testing, and/or staged rollouts of new functionality in a live environment while maintaining state continuity and providing little to no downtime during cutover.

In some embodiments, the debugger 330 can insert a conditional action into the anchor table based on a rule received by a user (e.g., of user device 110). The rule can place a condition on a debug point such that the debug action is taken only if the condition is satisfied. In some embodiments, the rule that triggers the conditional debugging can be based on complex Boolean conditions over packet fields and device state such as counters and variables. As an illustrative example, if the IP address of the packet satisfies a condition (e.g., is 1.1.1.1), the debug action can be to debug the packet (e.g., send the packet to the debugger 130); otherwise, the program can continue (e.g., the packet can continue through the pipeline). This conditional action can be enabled and disabled without the need to recompile the pipeline.

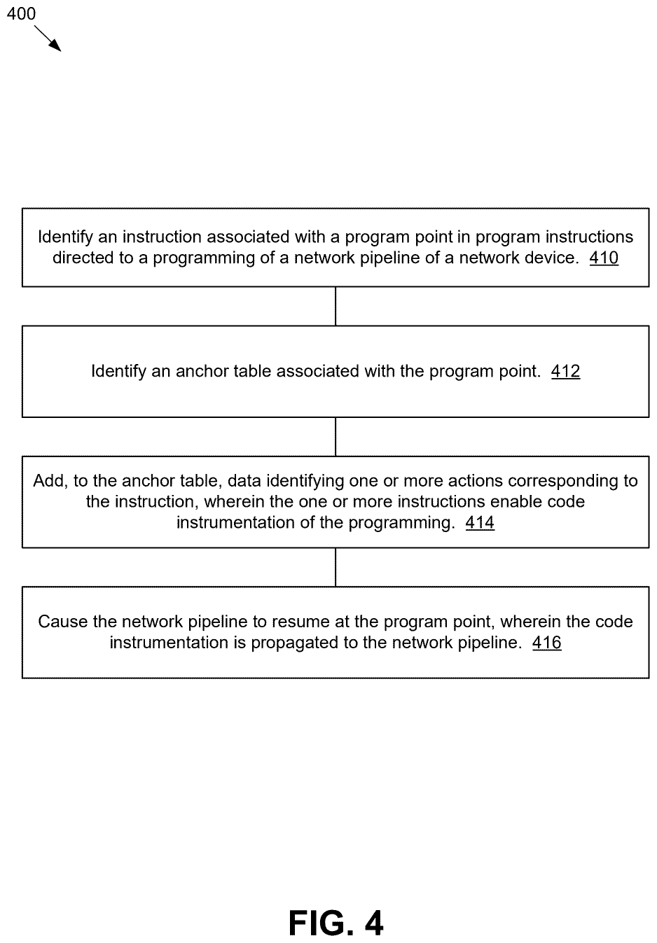

FIG. 4 is a flow diagram of an example method 400 for runtime pipeline insertion, instrumentation, and continuation, in accordance with one or more aspects of the present disclosure. In some embodiments, one or more operations of example method 400 can be performed by one or more components of FIG. 1, as described herein. Method 400 can be performed by processing logic that can include hardware (circuitry, dedicated logic, etc.), software (e.g., instructions run on a processing device), or a combination thereof. In one implementation, some or all of the operations of method 400 can be performed by host device 105. For example, some or all of the operations of method 400 can be performed by network device 102, as described herein.

At block 410, processing logic identifies an instruction associated with a program point in program instructions directed to a programming of a network pipeline of the network device (e.g., of network device 102). In some embodiments, the program point can correspond to one or more actions in the network pipeline that can be intercepted for debugging purposes. In some embodiments, the compiler can identify program points in the code that can be intercepted based on debug instructions that are associated with specific actions, such as packet forwarding operations, table lookup operations, and/or metadata modification operations. The program points can be identified automatically by the compiler during compilation when operating in debug mode, and/or can be specified by a user through debug instructions that indicate desired interception locations within the packet processing flow. As an illustrative example, the instruction can correspond to actions such as a “go to” operation that directs a packet between flow tables, an encapsulation operation, and/or a conditional processing operation that branches packet processing based on packet characteristics. The compiler can determine whether to insert an anchor table to facilitate runtime debugging operations, allowing the debugger to install conditional or unconditional breakpoints at the identified program points during pipeline execution.

In some embodiments, processing logic can identify an instruction associated with a program point by analyzing the compiled program instructions to locate specific operations that correspond to interceptable actions within the network pipeline. For example, processing logic can employ instruction parsing techniques to examine the instruction stream, looking for particular instruction types, such as “go to” operations that direct packets between flow tables, encapsulation operations, conditional processing operations that branch packet processing based on packet characteristics, and/or metadata modification operations. In some embodiments, processing logic can identify program points by examining instruction addresses, control flow markers, and/or debug annotations that were inserted by the compiler during the compilation process, e.g., when operating in debug mode.

In some embodiments, processing logic can correlate specific instructions opcodes and/or instruction patterns with their corresponding locations in the packet processing pipeline. In some embodiments, the compiler can embed metadata and/or debug indicators within the compiled code that mark interceptable program points. Processing logic can then parse this embedded information and establish direct associations between instructions and their pipeline locations. In some embodiments, processing logic can implement indicator table lookups, address mapping techniques, and/or control flow graph analysis to determine which instructions correspond to actionable program points where debugging operations can be performed.

In some embodiments, the relationship to network pipeline programming can be established through the analysis of domain-specific language constructs that define packet processing behavior within the network device. Processing logic can recognize instructions that implement match-action table operations, packet header parsing logic, conditional branching based on packet fields, and/or other network-specific processing functions.

At block 412, processing logic identifies an anchor table associated with the program point (e.g., anchor table 212 of FIG. 2). The anchor table can include a match-action table structure that is inserted by the compiler at specific program points within the packet processing pipeline to enable runtime debugging operations. The anchor table can serve as an interception point where packets can be diverted from their normal processing flow, allowing the debugger to examine packet state, modify packet contents or metadata, and control the continuation of packet processing. In some embodiments, processing logic identifies the anchor table by utilizing mapping information generated during the compilation process that associates each program point with a corresponding anchor table identifier. In some embodiments, during compilation, when the compiler inserts an anchor table at an identified program point, it can create a data structure or lookup table that maintains the relationship between the program point identifier and its associated anchor table reference. Processing logic can query the mapping structure using the program point identified at block 410 as a key to retrieve the corresponding anchor table reference.

In some embodiments, the identification mechanism can examine the compiled program instructions to locate an anchor table insertion point that was placed by the compiler. Processing logic can analyze the instruction sequence to identify specific opcodes and/or instruction patterns that indicate the presence of an anchor table, such as a lookup table instructions or branching operations that redirect packet flow to debugging infrastructure. The compiler can embed metadata within the compiled code that explicitly identifies anchor table locations. Processing logic can parse the metadata and extract anchor table identifiers from the instruction stream.

In some embodiments, processing logic can analyze the control flow graph of the compiled program to determine which anchors tables are reachable from the current program point. Processing logic can evaluate the program execution path and identify one or more anchor tables that couple potentially be encountered during packet processing from the identified program point. In embodiments where multiple table entries share the same action template, the identification process can include determining whether the program point corresponds to a shared anchor table that services multiple flow table entries. If so, processing logic can resolve the appropriate anchor table based on the specific template associated with the current program point.

At block 414, processing logic adds, to the anchor table, data identifying one or more actions corresponding to the instruction, wherein the one or more actions enable code instrumentation of the programming. In some embodiments, code instrumentation can refer to the dynamic insertion of executable monitoring, analysis, and/or modification logic into a packet processing pipeline at runtime, where the instrumentation can operate transparently within the existing pipeline framework to capture processing state information, implement conditional breakpoints, perform packet content analysis, and/or execute user-defined debugging operations while maintaining the integrity and continuity of the original packet processing flow. In some embodiments, at least one of the one or more actions causes a packet advancing through the network pipeline to be diverted to a debug tool (also referred to herein as a debugger or a debugger tool). In some embodiments, the debug tool can refer to a processing environment that operates independently of the network device's packet processing pipeline and can be configured to receive diverted packets containing encapsulated state information. In some embodiments, the debug tool can provide an interactive platform for real-time (or near real-time) packet analysis, state variable manipulation, conditional filtering operations, and/or controlled packet reinjection back into the network pipeline at continuation points. In some embodiments, the at least one of the one or more actions causes the packet advancing through the network pipeline to be diverted to the debug tool responsive to determine that a characteristic of the packet satisfies a predetermined criterion. In some embodiments, the characteristic of the packet corresponds to at least one of a source internet protocol (IP) address, a destination IP address, a protocol field, a network identifier, or a packet size threshold.

In some embodiments, processing logic extends the network pipeline with the code instrumentation at the program point. Processing logic can extend the network pipeline with code instrumentation at the program point by dynamically inserting debugging capabilities into the existing packet processing flow, without modifying the original pipeline architecture. Processing logic can extend the network pipeline by populating the anchor tables with action entries that implement specific instrumentation functions. By doing so, the anchor tables can be transformed from passive placeholders into active components that extend the pipeline's functionality by adding new processing stages and decision points. In some embodiments, the code instrumentation implementation can include executable instructions that can be dynamically inserted into the anchor table(s) to perform debugging operation(s) such as packet state capture, metadata modification, register value preservation, and/or conditional breakpoint activation. This instrumentation code can operate seamlessly within the existing pipeline framework, utilizing the same match-action table infrastructure while adding new capabilities for packet inspection and/or modification. The program point can serve as the integration location at which the instrumentation code interfaces with the original pipeline logic, to maintain state continuity through the debugging process.

In some embodiments, the one or more actions can include an instruction to encapsulate the packet by generating a copy of the state of the network pipeline and inserting the copy in a buffer of the packet. The state of the network pipeline can include, for example, packet headers, metadata values, register states, and/or parser position information that accumulated during the packet's traversal through preceding pipeline stages. In some embodiments, the encapsulation process can implement multiple encapsulation techniques, creating nested data structures where the original packet remains intact as the core payload while pipeline state information is systematically copied into designated buffer areas within the encapsulated packet structure.

In some embodiments, processing logic can add data to the anchor table by analyzing the identified instruction to determine the action(s) correspond to code instrumentation within the network pipeline. Processing logic can examiner the instruction type and/or context to generate corresponding action entries that can include conditional and/or unconditional debugging operations. For example, if the instruction corresponds to a packet forwarding operation, processing logic can generate action data that includes instructions to encapsulate the packet by creating a copy of the pipeline state (e.g., including headers, metadata, and/or register values) and inserting the copy into a buffer within the packet structure.

In some embodiments, to determine data identifying one or more actions, processing logic can analyze the instruction's role within the packet processing flow and the debugging conditions specified by the debugger tool. In some embodiments, processing logic can generate action entries that include instructions to divert encapsulated packets to a debugger tool. In some embodiments, processing logic can generate conditional action entries that direct packets to debugging operations, e.g., when specific packet characteristics satisfy predetermined criteria, such as matching particular IP addresses, protocol fields, and/or packet size thresholds.

In some embodiments, to add data to the anchor table, processing logic can execute table insertion operations that populate the anchor table with the generated action entries. Processing logic can employ dynamic table modification techniques to insert new entries into the anchor table structure, which can involve formatting and/or indexing the action data during packet processing. In some embodiments, processing logic can maintain the relationship between the instruction and the corresponding action(s) by creating mapping entries that link the instruction identifier with its associated debugging actions.

At block 416, processing logic causes the network pipeline to resume at the program point, wherein the code instrumentation is propagated to the network pipeline. In some embodiments, processing logic inserts a dynamic mapping table (e.g., table 320 of FIG. 3) to direct a packet reinjected from a debug tool back to a second program point succeeding the program point or to another program point selected by a user.

In some embodiments, the dynamic mapping table can maintain mappings between debug point identifiers and their corresponding pipeline stage locations, enabling packet redirection after debugging operations are performed. In some embodiments, when a packet is ready for reinjection after debugging operations, processing logic can query the dynamic mapping table, e.g., using debug the debug identifier associated with the packet to determine the pipeline location where processing should resume. In some embodiments, the reinjection process can include restoring the state of the networking pipeline according to the values stored in buffer in the packet, allowing the packet to resume processing with the context that existed when it was intercepted. In some embodiments, redirecting packets to the succeeding program point can involve multiple coordinated operations that include state restoration and pipeline context reconstruction. For example, when the debug tool completes its analysis and/or modifications, it can reinject the packet along with any modified state information back into the network pipeline. Processing logic can execute buffer restoration mechanisms that extract the pipeline state information from the encapsulated packet buffer and restore the network device's processing context to match the state that existed when the packet was intercepted. The restoration process can include reloading register values, metadata fields, parser position indicators, and/or control flow state variables. In some embodiments, the packet itself can serve as a program counter, e.g., by storing execution state information that can track its current pipeline position and processing history, enabling packet routing through the debugging process.

In some embodiments, the relationship between the program point and the second program point succeeding the program point is sequential within the packet processing pipeline. The second program point can represent the next logical stage in the packet processing flow that would have been executed if the packet had not been diverted for debugging. The program point can serve as the interception location where the packet was captured and sent to the debug tool, while the second program point can represent the continuation point where pipeline processing resumes. In some embodiments, the sequential relationship can be maintained through the compiler's analysis of the pipeline control flow during compilation.

In some embodiments, processing logic can create a shadow pipeline (or multiple shadow pipelines) that operates concurrently with the active pipeline. Shadow pipelines can enable versioning and/or A/B testing capabilities. Processing logic can utilize just-in-time compilation to convert high-level debugging rule(s) provided by users into machine-readable instructions for live insertion into anchor table(s).

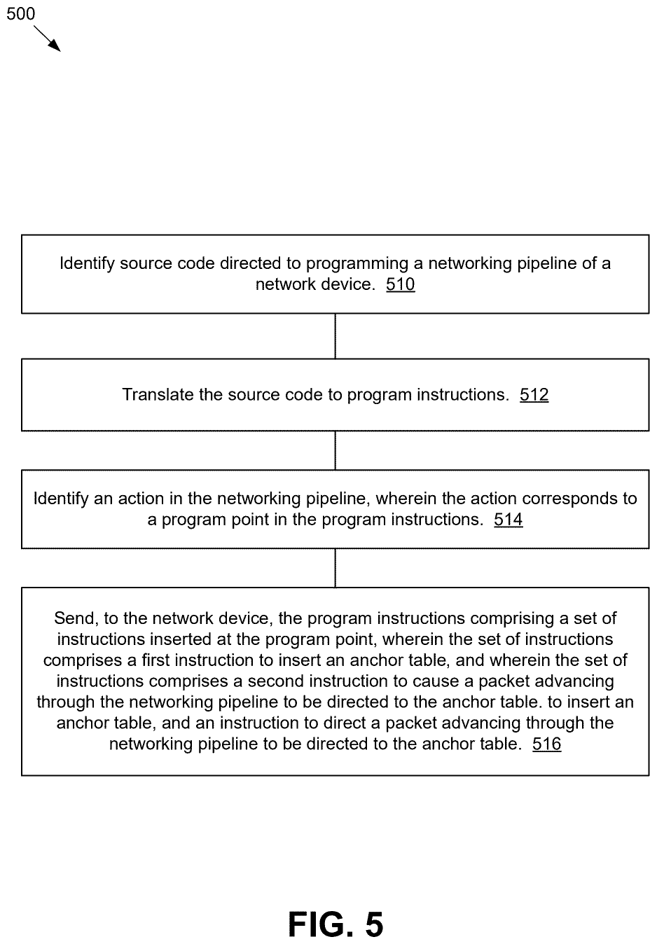

FIG. 5 is a flow diagram of an example method 500 for implementing a compiler insertion of anchor tables, in accordance with one or more aspects of the present disclosure. In some embodiments, one or more operations of example method 500 can be performed by one or more components of FIG. 1, as described herein. Method 500 can be performed by processing logic that can include hardware (circuitry, dedicated logic, etc.), software (e.g., instructions run on a processing device), or a combination thereof. In one implementation, some or all of the operations of method 500 can be performed by host device 105. In another implementation, some or all of the operations of method 500 can be performed device 102.

At block 510, processing logic identifies source code directed to programming of a networking pipeline of a network device (e.g., device 102). In some embodiments, the source code can be received, e.g., from user device 110, from a component operating on host 105, and/or from another device connected to network 140.

In some embodiments, processing logic identifies source code directed to programming of a networking pipeline of a network device through analysis of domain-specific language constructs and/or programming patterns that are characteristic of network packet processing applications. In some embodiments, processing logic may use detection mechanisms such as lexical analysis to identify domain-specific programming language tokens, semantic analysis to understand the intent and/or structure of network processing operations, and/or pattern matching algorithms that recognize common networking pipeline programming paradigms. In some embodiments, the identification criteria for source code targeting networking pipeline programming can include the presence of packet processing primitives, network protocol handling routines, and/or traffic management functions that are characteristics of programmable network devices.

At block 512, processing logic translates the source code to program instructions. In some embodiments, translating can refer to the computational process of converting high-level programing language constructs into executable machine code or intermediate representations that can be processed by the target network device hardware. In some embodiments, the translation can preserve the semantic meaning and operational intent of the original source code while adapting it to the instruction set architecture and execution model of the destination processing environment. In some embodiments, processing logic translates the source code to program instructions through a compilation process that converts domain-specific language constructs into machine-readable instructions executable by the network device. In some embodiments, processing logic can employ a multi-stage compilation pipeline that includes lexical analysis to tokenize the source code into recognizable language elements, syntactic analysis to parse the token stream and construct an abstract syntax tree representing the program structure, and semantic analysis to validate the program logic and resolve symbol references. The translation process can include intermediate code generation that creates platform-independent representations of the source code before final code generation produces the target machine instructions.

In some embodiments, processing logic may implement compilation techniques tailored for network pipeline programming, including the analysis of match-action table definitions, packet header parsing specifications, and/or control flow graphs that define packet processing behavior, for example. During translation, processing may can generate specific instruction sequences for table lookup operations, packet forwarding logic, metadata manipulation commands, and/or conditional branching based on packet characteristics. In some embodiments, the compilation process can include optimization stages that analyze the program instructions to improve execution efficiency, eliminate redundant operations, and/or optimize memory usage within the constraints of the target network device architecture.

In some embodiments, processing logic can incorporate just-in-time (JIT) compilation capabilities that enable dynamic translation of high-level programming constructs into executable instructions during runtime. The JIT compilation process can enable the processing logic to convert user-defined rules, debugging specifications, and/or pipeline modifications into machine instructions that can be directly executed by the network device without complete program recompilation. In some embodiments, processing logic can maintain symbol tables, manage memory allocation for program instructions, and/or link between different program modules to produce an executable program suitable for deployment on the target network device.

In some embodiments, the method may further comprise identifying one or more debugging rules and performing JIT compilation to convert the debugging rules into executable instructions for live insertion into the anchor table during runtime. The debugging rules may be received from a user device, specified through a debugging interface, and/or derived from automated debugging policies. In some embodiments, the debugging rules may include packet filtering criteria that specify conditions for intercepting specific packets based on characteristics, such as source or destination IP addresses, protocol fields, and/or packet size thresholds. In some embodiments, the debugging rules may include instrumentation requirements that define monitoring or analysis operations to be performed on intercepted packets, such as counter insertions, state capture operations, and/or metadata logging functions. In some embodiments, the debugging rules may include breakpoint conditions that specify when packet processing should be paused or diverted to enable interactive debugging operations.

In some embodiments, the JIT compilation process may dynamically translate the debugging rules into machine-readable instructions that are compatible with the anchor table structure and the network device's instruction set architecture. The JIT compiler may parse the debugging rule syntax, validate the rule parameters against the current pipeline configuration, and generate optimized instruction sequences for efficient execution within the packet processing pipeline, in embodiments. The resulting instructions are inserted into the anchor table during runtime without requiring recompilation of the original pipeline program or interruption of ongoing packet processing operations. This dynamic rule insertion capability enables developers to adapt debugging operations in response to observed network conditions, evolving troubleshooting requirements, and/or newly identified areas of interest within the packet processing flow, in embodiments.

At block 514, processing logic identifies an action in the networking pipeline, wherein the action corresponds to a program point in the program instructions. In some embodiments, processing logic identifies an action in the networking pipeline by analyzing the program instructions to locate specific operations that correspond to interceptable processing stages within the packet processing flow of the networking pipeline. In some embodiments, processing logic can examine the instruction sequence to identify particular action types, such as packet forwarding operations that direct packets between flow tables, table lookup operations that perform match-action processing on packet headers or metadata, encapsulation operations that modify packet structure, and/or conditional processing operations that implement branching logic based on packet characteristics, for example. The identification process can involve correlating network-specific actions with their corresponding program points in the program instructions.

In some embodiments, processing logic can employe instruction pattern recognition techniques to detect actions that are suitable for debugging instrumentation, such as “go to” operations that transfer packet processing control between different pipeline stages, metadata modification operations that alter packet processing state, and/or packet transformation operations that change packet headers and/or payload content. In some embodiments, processing logic can analyze the control flow graph of the compiled program to identify decision points, processing stages, and/or state transitions that represent actionable program points where debugging operations can be inserted without disruption the packet processing flow.

In some embodiments, processing logic can establish the correspondence between actions and program points by analyzing the instruction addressing scheme and the pipeline execution model. For example, when processing logic identifies an action within the networking pipeline, processing logic can determine the associated program point by examining the instruction's location within the compiled code, its relationship to other pipeline operations, and/or its role in the overall packet processing sequence. Processing logic can map network pipeline actions to locations in the program instructions where anchor table(s) can be inserted, debugging operation(s) can be performed, and/or packet processing can be intercepted and resumed without losing pipeline state continuity.

At block 516, processing logic sends, to the network device, the program instructions comprising a set of instructions inserted at the program point. In some embodiments, processing logic can transfer a firmware image containing the compiled program instructions to memory of the network device, and/or may transfer the program instructions directly to the network device through established communication pathways. In some embodiments, the transmission process can involve encoding the set of instructions, including the first instruction to insert an anchor table and the second instruction to cause packet direction to the anchor table, in a format compatible with the network device's instruction set architecture, enabling the network device to receive, load, and execute the transmitted program instructions within its packet processing pipeline. The set of instructions can include a first instruction to insert an anchor table, and a second instruction to cause a packet advancing through the networking pipeline to be directed to the anchor table. For example, the first instruction can create an anchor table, which services as a match-action table structure that acts as an interception point within the packet processing pipeline where debugging operations can be performed. The second instructions can implement packet redirection logic that diverts packets from the processing flow to the anchor table, enabling the packets to be intercepted for debugging analysis, state examination, and/or modification before continuing through the pipeline.

In some embodiments, the set of instructions comprises a third instruction to encapsulate the packet by generating a copy of the state of the network pipeline and inserting the copy in a buffer of the packet. For example, the third instruction can create a snapshot of the pipeline's current state, including packet headers, metadata values, register states, and/or parser position information, and store the state information in a designated buffer area within the packet structure. The encapsulation process can enable the packet to remain intact as the core payload while carrying its own processing history and/or context in a buffer, allowing the debugging system to maintain visibility into the packet's journey through the pipeline, and enabling state restoration when the packet is later reinjected back into the pipeline for continued processing.

In some embodiments, the set of instructions can include a fourth instruction to send the encapsulated packet (e.g., containing both the original packet data and captured pipeline state) to a debug tool. The debug tool can enable code instrumentation. For example, the debug tool can serve as an interactive analysis platform where developers can examine packet contents, modify metadata values, alter processing parameters, and/or implement runtime code changes. In some embodiments, the code instrumentation capability can allow the debug tool to insert monitoring code, modify packet processing behavior, and/or extend pipeline functionality through software-based analysis and manipulation.

In some embodiments, the second instruction is a conditional instruction that causes the packet to be directed to the anchor table responsive to determining that a characteristic of the packet satisfies a predetermined criterion. In some embodiments, the characteristic of the packet corresponds to at least one of a source internet protocol (IP) address, a destination IP address, a protocol field, a network identifier, or a packet size threshold.

In some embodiments, processing logic can identify a plurality of actions that utilize a first action template, e.g., by analyzing the program instructions to locate multiple entries that reference the same underlying action structure with variable parameters. Processing logic can examine action definitions within the packet processing pipeline to identify common operational patterns, such as multiple “forward to port X” actions where the code forwarding logic remains the same but the destination port parameter varies. The identification process can involve parsing action signatures and comparing them to template structures to determine which actions share the same fundamental processing logic while differing in their parameter values, such as port numbers, VLAN tags, and/or quality-of-service markings, for example.

The first instruction can cause multiple table entries corresponding to the plurality of actions to share the anchor table. In some embodiments, processing logic can create a template-based lookup structure where each action template defines a common set of operations with variable parameters. For example, when the compiler generates the first instruction, it can establish a single anchor table that includes parameterized match conditions and actions capable of handling variations of the template. The anchor table can maintain a mapping between template identifiers and their corresponding parameter sets, enabling the single anchor table to service multiple flow table entries while preserving the specific parameter values associated with each individual table entry. This share anchoring mechanism can reduce or eliminate the need to create separate anchor tables for each action variation, and instead allow one anchor table to intercept and process actions that conform to the same template structure.

In some embodiments, processing logic can insert a second set of instructions at a second program point succeeding the program point. The second set of instructions can include a fifth instruction to restore the state of the networking pipeline according to the set of values in the buffer of the packet. The second set of instructions can include an instruction to resume advancement of the packet through the networking pipeline at the second program point. For example, processing logic can determine the second program point by examining the control flow graph of the program instructions to locate the pipeline stage that immediately follows the original interception point in the packet processing sequence. Processing logic can analyze the instruction addressing scheme and pipeline execution model to identify the second program point that presents the location where packet processing would naturally resume after completing operations at the first program point. In some embodiments, processing logic can insert the second set of instructions by modifying the program instructions to embed the second set of instructions at the identified second program point location. For example, processing logic can update the instruction stream to include restoration instructions that can reload pipeline state information from the packet buffer, including register values, metadata fields, and/or parser position indicators. In some embodiments, processing logic can maintain program counter relationship and/or memory address mappings between the first and second program points to provide proper instruction sequencing.

In some embodiments, processing logic can maintain the relationship between the first program point and the succeeding second program point by creating a sequential execution pathway that preserves the program flow while accommodating the debugging infrastructure. The second program point can serve as the reentry location where packets return to the pipeline after debugging operations, with the second set of instructions designed to restore the network device's processing context to match the state that would have existed at the location during uninterrupted pipeline execution.

In some embodiments, the fifth instruction to restore the state of the networking pipeline can implement a state recovery system that extracts pipeline state information from the encapsulated buffer and restores the network device's processing context to match the state that existed when the packet was intercepted. The restoration process can include reloading register values, metadata fields, parser position indicators, and/or control flow state variables from structured data fields within the buffer into their corresponding hardware or software structures within the network device. In some embodiments, the buffer format may include metadata that specifies memory locations and/or data types for each state element.

In some embodiments, the instruction to resume advancement of the packet through the networking pipeline can utilize dynamic mapping mechanisms that correlate the second program point with specific pipeline stage addresses to enable packet continuation. This resumption process can involve updating packet routing tables, adjusting pipeline flow control parameters, and/or synchronizing the packet's processing context with the current pipeline state. In some embodiments, the resumption instruction can implement packet-as-program-counter functionality, where the packet itself carries execution state information that tracks its current pipeline position and processing history, enabling packet routing through the continuation process.

In some embodiments, the coordination between restoration and resumption instructions can support pipeline state continuity by maintaining temporal relationships between the packet's modified state and the pipeline's execution environment. The restoration instruction can validate the integrity of the buffer data before applying state changes, while the resumption instruction can perform pipeline synchronization checks to confirm that the packet can safely continue processing at the designated second program point. This coordinated approach can support the seamless transition from debugging operations back to pipeline execution while preserving modifications made during the debugging process.

In some embodiments, processing logic can maintain a dynamic mapping table that maps debug point identifiers to corresponding networking pipeline locations for directing reinjected packets back to specific pipeline locations. The dynamic mapping table can include debug point identifiers, each of which corresponds to a networking pipeline location. In some embodiments, processing logic can maintain the dynamic mapping table by implementing a lookup structure that establishes and manages associations between unique debug point identifiers and their corresponding pipeline stage locations within the network device. For example, the dynamic mapping table can be implemented as a hash table, associative array, or similar data structure that enables efficient key-value pair storage and retrieval operations. Each entry in the mapping table can contain a debug point identifier as the primary key and a pipeline location descriptor as the associated value, which can include specific information such as pipeline stage addresses, table identifiers, processing context parameters, and/or state restoration metadata.

In some embodiments, processing logic can generate a unique debug point identifier when a packet is intercepted at a specific program point within the pipeline. The identifiers can be sequential numbers, hash values, and/or composite keys that incorporate timing information, packet characteristics, and/or pipeline state data, so that each identifier is unique (e.g., across all possible anchor points in the program). As used herein, an anchor point refers to a designated location within the packet processing pipeline graph where debugging operations can be performed. An additional packet tracking identifier can be used to uniquely track each debug packet when multiple packets are being debugged concurrently, and to maintain tracking continuity for each packet through multiple reinjections while being processed by the pipeline. Processing logic can maintain identifier generation counters, timestamp mechanisms, and/or other tracking systems to prevent identifier collisions and enable correlation between intercepted packets, reinjected packets, and their corresponding pipeline locations. In some embodiments, the pipeline includes multiple anchor points positioned at strategic locations within the packet processing graph, and each anchor point is assigned a unique debug point identifier through the mapping mechanism described herein.

In some embodiments, in addition to the debug point identifiers associated with anchor points, the debugger generates and preserves, for each packet, a unique packet tracking identifier across all debug events. The packet tracking identifier can be implemented as an ingress timestamp or other unique value that is assigned when the packet first enters the debugging process. In some embodiments, the packet tracking identifier is assigned by the debugger upon initial packet interception. In some embodiments, the network device hardware assigns the packet tracking identifier at ingress. The packet tracking identifier can be stored as metadata within the packet's buffer space and can persist with the packet as it traverses through each anchor point in the pipeline, including through multiple recirculation and reinjection cycles. This persistent association enables the debugger to correlate all debug events associated with the same packet throughout its entire journey through the pipeline.

In some embodiments, the debug events can be processed asynchronously and out of order, and the debugger reconstructs the full ordered sequence of debug points using the unique debug point identifier along with the packet tracking identifier. The debug point identifier indicates the specific anchor point location where an interception occurred, while the packet tracking identifier identifies which specific packet was intercepted, enabling accurate reconstruction of the packet's complete processing history even when debug events arrive at the debugger in a different order than they occurred in the pipeline.

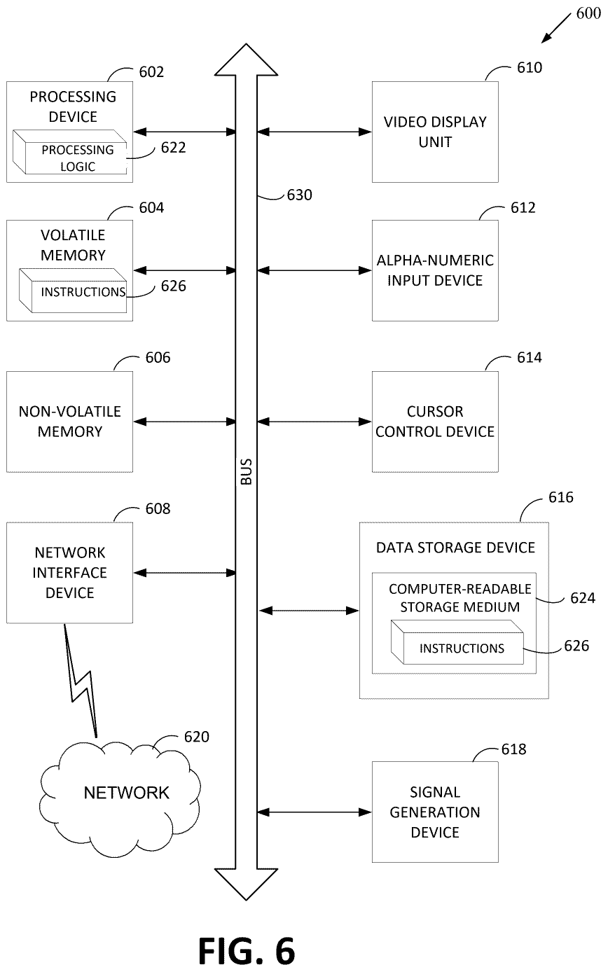

FIG. 6 illustrates a block diagram illustrating an exemplary computer device 600, in accordance with implementations of the present disclosure. Computer device 600 can correspond to one or more components of host 105, as described above. Example computer device 600 can be connected to other computer devices in a LAN, an intranet, an extranet, and/or the Internet. Computer device 600 can operate in the capacity of a server in a client-server network environment. Computer device 600 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 600 can include a processing device 602 (also referred to as a processor, CPU, or GPU), a volatile memory 604 (or main memory, e.g., read-only memory (ROM), flash memory, dynamic random access memory (DRAM) such as synchronous DRAM (SDRAM), etc.), a non-volatile memory 606 (e.g., flash memory, static random access memory (SRAM), etc.), and a secondary memory (e.g., a data storage device 616), which can communicate with each other via a bus 630.

Processing device 602 (which can include processing logic 622) represents one or more general-purpose processing devices such as a microprocessor, central processing unit, or the like. More particularly, processing device 602 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 can also be one or more special-purpose processing devices such as an ASIC, a FPGA, a digital signal processor (DSP), network processor, or the like. In accordance with one or more aspects of the present disclosure, processing device 602 can be configured to execute instructions to perform methods 400 and/or 500 for implementing debugging in a packet processing pipeline.

Example computer device 600 can further comprise a network interface device 608, which can be communicatively coupled to a network 620. Example computer device 600 can further comprise a video display 610 (e.g., a liquid crystal display (LCD), a touch screen, or a cathode ray tube (CRT)), an alphanumeric input device 612 (e.g., a keyboard), a cursor control device 614 (e.g., a mouse), and an acoustic signal generation device 618 (e.g., a speaker).

Data storage device 616 can include a computer-readable storage medium (or, more specifically, a non-transitory computer-readable storage medium) 624 on which is stored one or more sets of executable instructions 626. In accordance with one or more aspects of the present disclosure, executable instructions 626 can comprise executable instructions to perform methods 400 and/or 500 for implementing debugging in a packet processing pipeline.

Executable instructions 626 can also reside, completely or at least partially, within volatile memory 604 and/or within processing device 602 during execution thereof by example computer device 600, volatile memory 604 and processing device 602 also constituting computer-readable storage media. Executable instructions 626 can further be transmitted or received over a network via network interface device 608.

While the computer-readable storage medium 624 is shown in FIG. 6 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a network device to:
identify an instruction associated with a program point in program instructions directed to a programming of a network pipeline of the network device;
identify an anchor table associated with the program point;
add, to the anchor table, data identifying one or more actions corresponding to the instruction, wherein the one or more actions enable code instrumentation of the programming; and
cause the network pipeline to resume at the program point, wherein the code instrumentation is propagated to the network pipeline.

2. The system of claim 1, wherein the network device is further to:
extend the network pipeline with the code instrumentation at the program point.

3. The system of claim 1, wherein at least one of the one or more actions causes a packet advancing through the network pipeline to be diverted to a debug tool.

4. The system of claim 3, wherein the at least one of the one or more actions causes the packet advancing through the network pipeline to be diverted to the debug tool responsive to determine that a characteristic of the packet satisfies a predetermined criterion.

5. The system of claim 4, wherein the characteristic of the packet corresponds to at least one of a source internet protocol (IP) address, a destination IP address, a protocol field, a network identifier, or a packet size threshold.

6. The system of claim 1, wherein the network device is further to:
insert a dynamic mapping table to direct a packet reinjected from a debug tool back to a second program point succeeding the program point.

7. The system of claim 1, wherein the network device is further to:
store a pipeline location identifier in a buffer of a packet advancing through the network pipeline, wherein the pipeline location identifier tracks a current position of the packet within the network pipeline; and
generate a unique packet tracking identifier for the packet, wherein the unique packet tracking identifier persists with the packet through one or more reinjections within the network pipeline.

8. The system of claim 1, wherein the network device is further to:
create a shadow network pipeline that operates concurrently with the network pipeline, wherein the shadow network pipeline comprises one or more rules derived from existing flow entries of the network pipeline; and
steer packets between the network pipeline and the shadow pipeline to enable pipeline versioning.

9. A method comprising:
identifying source code directed to programming a networking pipeline of a network device;
translating the source code to program instructions;
identifying an action in the networking pipeline, wherein the action corresponds to a program point in the program instructions; and
sending, to the network device, the program instructions comprising a set of instructions inserted at the program point, wherein the set of instructions comprises a first instruction to insert an anchor table, and wherein the set of instructions comprises a second instruction to cause a packet advancing through the networking pipeline to be directed to the anchor table.

10. The method of claim 9, wherein the set of instructions comprises a third instruction to encapsulate the packet by generating a copy of a state of the network pipeline and inserting the copy in a buffer of the packet.

11. The method of claim 9, wherein the set of the instructions comprises a fourth instruction to send the encapsulated packet to a debug tool.

12. The method of claim 9, further comprising:
inserting a second set of instructions at a second program point succeeding the program point, wherein the second set of instructions comprises a fifth instruction to restore a state of the networking pipeline according to a set of state values of a buffer of the packet, and wherein the second set of instructions comprises an instruction to resume advancement of the packet through the networking pipeline at the second program point.

13. The method of claim 9, further comprising:
identifying the action comprises identifying a plurality of actions that utilize a first action template, wherein the first instruction causes multiple table entries corresponding to the plurality of actions to share the anchor table.

14. The method of claim 9, further comprising:
maintaining a dynamic mapping table comprising a plurality of debug point identifiers, wherein each debug point identifier of the plurality of debug point identifiers corresponds to a networking pipeline location for directing reinjected packets back to the networking pipeline location.

15. The method of claim 9, wherein the second instruction is a conditional instruction that causes the packet to be directed to the anchor table responsive to determining that a characteristic of the packet satisfies a predetermined criterion.

16. The method of claim 15, wherein the characteristic of the packet corresponds to at least one of a source internet protocol (IP) address, a destination IP address, a protocol field, a network identifier, or a packet size threshold.

17. The method of claim 9, further comprising:
identifying one or more debugging rules; and
performing just-in-time compilation to convert the one or more debugging rules into a second set of instructions for live insertion into the anchor table during runtime, wherein the one or more debugging rules comprise at least one of a packet filtering criterion, an instrumentation requirement, or a breakpoint condition.

18. A non-transitory computer-readable storage medium storing instructions that, when executed by a processing device, cause the processing device to perform operations comprising:
identifying an instruction associated with a program point in program instructions directed to a programming of a network pipeline of a network device;
identifying an anchor table associated with the program point;
adding, to the anchor table, data identifying one or more actions corresponding to the instruction, wherein the one or more actions enable code instrumentation of the programming; and
causing the network pipeline to resume at the program point, wherein the code instrumentation is propagated to the network pipeline.

19. The non-transitory computer-readable storage medium of claim 18, further comprising:
extending the network pipeline with the code instrumentation at the program point.

20. The non-transitory computer-readable storage medium of claim 18, wherein at least one of the one or more actions causes a packet advancing through the network pipeline to be diverted to a debug tool.
